(19) United States
(12) Patent Application Publication
(10) Pub. No.: US 2022/0391957 A1
(43) Pub. Date: Dec. 8, 2022

(54) SYSTEM AND METHOD FOR PROVIDING REAL-TIME ORDER ASSISTANCE

(71) Applicant: DASH NOW LLC, LENEXA, KS (US)

(72) Inventors: JOSEPH LAYNE, SHAWNEE, KS (US); BRETT KARLIN, SHAWNEE, KS (US)

(21) Appl. No.: 17/740,552

(22) Filed: May 10, 2022

Related U.S. Application Data
(60) Provisional application No. 63/195,862, filed on Jun. 2, 2021.

(51) Int. Cl. G06Q 30/06; G06F 3/16; H04B 5/00

(52) U.S. Cl. CPC G06Q 30/0613; G06F 3/165; H04B 5/0056; G06Q 30/0641; G06Q 20/12

(57) ABSTRACT

A system and method for providing real-time order assistance is disclosed. The system receives a request for order assistance from a customer device of a customer. The system also establishes an audio connection and a data connection between the customer device and an order assistant device of an order assistant available to assist with the customer's request for order assistance. The system then manages an order session by (a) enabling audio communication between the customer and the order assistant via the audio connection and (b) enabling the customer and the order assistant to create an order via the data connection. In addition, the system closes the order session when the order is complete to enable fulfillment of the order.

### CROSS-REFERENCE TO RELATED APPLICATIONS

This application is based on and claims priority to U.S. Provisional Application Ser. No. 63/195,862 filed on Jun. 2, 2021, which is incorporated herein by reference in its entirety.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

Many types of restaurants have one or more drive-through lines that enable customers to place an order while staying in their vehicles. Many times, the restaurant utilizes a speaker system that includes a drive-through speaker for each drive-through line and a headset worn by an employee taking orders inside the restaurant. If this technology is not working correctly, communication errors can occur and the customer may not receive the correct food and/or drink products that were ordered. In addition, some customers may not be proficient in the native language spoken by the employee, which can also cause communication errors. Further, while some restaurants reduce communication errors by providing a digital screen adjacent each drive-through line that enables customers to view their orders, there are still many restaurants that have not installed digital screens due to cost considerations or other factors.

Another problem with existing ordering technology is that restaurants must use on-site employees to take orders and payments using point-of-sale terminals. While this may not be a significant issue during peak hours when the drive-through lines are sufficiently staffed, it can lead to problems during slow periods of the day when the restaurant operates with fewer employees. Restaurants often experience unexpected bursts in ordering outside of the normal peak hours due to unforeseen events, such as large groups of people exiting a concert or sporting event or an event drawing unexpected crowds. Most restaurants are not equipped to handle these additional bursts in volume and may lose business due to their inability to provide timely service to additional customers during these times.

Even if the drive-through lines of a restaurant are sufficiently staffed, the existing ordering technology typically requires customers to wait for all the customers in vehicles in front of them to place their orders before they can place their own orders. In some cases, a customer is indecisive when placing an order or places a relatively large order, which delays the ordering process for customers behind that customer's vehicle. Customers must also wait for the customers in vehicles in front of them to pay for their orders once they get to the pick-up window. In some cases, a customer has a credit card and the employee must run the payment on the point-of-sale terminal and wait for the response from the credit card processing gateway, which can take upwards of sixty seconds. The employee then asks if the customer would like a receipt and, if so, requests a printed receipt from the point-of-sale terminal and provides it to the customer. Meanwhile, all of the vehicles behind this vehicle are waiting to pull forward, some of which haven't even had a chance to place their orders.

Thus, there remains a need in the art for ordering technology that overcomes some or all of the drawbacks associated with conventional ordering systems and/or that offers other advantages compared to conventional ordering systems.

### BRIEF SUMMARY OF THE INVENTION

The present invention is directed to a system and method for providing real-time order assistance to a customer placing an order at a restaurant or other retail location, or through a website that enables the ordering of various types of products or services. The customer places the order using the customer's own computing device. The customer device may comprise, for example, a mobile phone, an in-vehicle computer, a personal computing tablet, a smart watch, a personal computer, or a laptop computer, or any other type of Internet-enabled device. An order assistant assists the customer with order placement using the order assistant's computing device. The order assistant device may comprise, for example, a mobile phone, a personal computing tablet, a personal computer, or a laptop computer (in embodiments where the order assistant works remotely from home or from a call center), a point-of-sale terminal (in embodiments where the order assistant works at a retail store), or any other type of Internet-enabled device. In some embodiments, the order assistant may not be a person, e.g., it is possible to use a smart automated order assistant via the use of artificial intelligence (AI) technology.

In accordance with the invention, two connections are established between the customer device and the order assistant device— a real-time audio connection and a real-time data connection. The real-time audio connection is established to enable the customer and the order assistant to speak with each other during the order session. The real-time data connection is established to enable the customer and the order assistant to create (i.e., view and/or update) the order on their respective devices during an order session, including the submission of order data and payment data.

An order assistance system in accordance with one embodiment of the invention described herein is programmed to receive an initial order request from a customer device of a customer and, in response, provide a first user interface for rendering by a first Internet-enabled application on the customer device, wherein the first user interface enables selection of a request for order assistance. The system is also programmed to receive the request for order assistance from the customer device and, in response, provide a second user interface for rendering by a second Internet-enabled application on an order assistant device of an order assistant. In addition, the system is programmed to transmit a transaction identifier to each of the customer device and the order assistant device for use in transmitting a plurality of connection requests. The system is also programmed to receive the connection requests from the customer device and the order assistant device and, in response, establish an audio connection and a data connection between the first and second Internet-enabled devices. The system is further programmed to manage an order session by (a) enabling audio communication between the customer and the order assistant via the audio connection and (b) enabling the customer and the order assistant to create an order via the data connection. In addition, the system is programmed to close the order session when the order is complete to enable fulfillment of the order.

An order assistance system in accordance with another embodiment of the invention described herein is programmed to receive a request for order assistance from a customer device of a customer and, in response, identify an order assistant device of an order assistant available to assist with the request for order assistance. The system is also programmed to transmit a transaction identifier to each of the customer device and the order assistant device for use in transmitting a plurality of connection requests. In addition, the system is programmed to receive the connection requests from the customer device and the order assistant device and, in response, establish an audio connection and a data connection between the customer device and the order assistant device. The system is further programmed to manage an order session by (a) enabling audio communication between the customer and the order assistant via the audio connection and (b) enabling the customer and the order assistant to create an order via the data connection. In addition, the system is programmed to close the order session when the order is complete to enable fulfillment of the order.

An order assistance system in accordance with yet another embodiment of the invention described herein is programmed to receive a request for order assistance from a customer device of a customer. The system is also programmed to establish an audio connection and a data connection between the customer device and an order assistant device of an order assistant available to assist with the request for order assistance. The system is further programmed to manage an order session by (a) enabling audio communication between the customer and the order assistant via the audio connection and (b) enabling the customer and the order assistant to create an order via the data connection.

Various other embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1 depicts a network diagram of one embodiment of a system for providing real-time order assistance using data and audio connections between Internet-enabled devices of a customer and an order assistant in accordance with the invention;

FIG. 2 depicts a block diagram of one embodiment of an order assistance system that may be used in the system of FIG. 1;

FIG. 3 depicts a process flow diagram of an exemplary method for registering order assistants;

FIGS. 4A-4B depict a process flow diagram of an exemplary method for enabling a customer to place an order with the assistance of an order assistant;

FIGS. 5A-5B depict a process flow diagram of an exemplary method for creating an order;

FIG. 6 depicts a process flow diagram of an exemplary method for updating an order during an order session;

FIG. 7 depicts a process flow diagram of an exemplary method for sending order details during an order session;

FIG. 8 depicts a process flow diagram of an exemplary method for making a payment during an order session;

FIG. 9 depicts a process flow diagram of an exemplary method for fulfilling an order when the order session is closed;

FIG. 10 depicts an exemplary data connection and audio connection between the Internet-enabled devices of the customer and order assistant;

FIGS. 11A-11C depict exemplary screen shots of the Intern-enabled device of the customer;

FIG. 12 illustrates an example of how customers in a drive-through line can place orders by speaking with order assistants directly from their Internet-enabled devices;

FIG. 13 illustrates an example of how customers in a retail parking lot can place orders by speaking with order assistants directly from their Internet-enabled devices;

FIG. 14 illustrates an example of how customers sitting down at a restaurant can place orders by speaking with order assistants directly from their Internet-enabled devices; and

FIG. 15 illustrates an example of how customers visiting a website can place orders by speaking with order assistants directly from their Internet-enabled devices.

### DETAILED DESCRIPTION OF EXEMPLARY EMBODIMENTS

The present invention is directed to a system and method for providing real-time order assistance using data and audio connections between Internet-enabled devices of a customer and an order assistant. While the invention will be described in detail below with reference to various exemplary embodiments, it should be understood that the invention is not limited to the specific configuration or methodologies of any of these embodiments. In addition, although the exemplary embodiments are described as embodying several different inventive features, those skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

In general terms, the system and method of the present invention enable a customer to obtain assistance with placement of an order via a real-time order session with an order assistant. The customer may be anyone who wishes to place an order with a company or other seller (such as a retail store). The order assistant may be an employee of the company, a subcontractor of the company, or an employee or subcontractor of a third party hired for the purpose of assisting customers with placing orders with the company. It should be understood that different companies may have different names for the order assistant, such as customer service representative, order taker, order specialist, agent, waiter, server, or the like. The order assistant is preferably trained on the company's products or services so as to be able to answer any questions that the customer may have during an order session. Alternatively, the order assistant may be a smart automated order assistant that uses artificial intelligence (AI) technology to assist customers with placing orders as described herein.

The customer is able to request assistance with placement of an order using the customer's own Internet-enabled device, which is referred to herein as the “customer device.” The customer device may be any type of computing device capable of connecting to the Internet, such as a mobile phone, an in-vehicle computer, a personal computing tablet, a smart watch, a personal computer, or a laptop computer. Of course, other types of Internet-enabled devices may be used within the scope of the present invention.

The order assistant is able to provide order assistance services to a plurality of customers using an Internet-enabled device, which is referred to herein as the “order assistant device.” The order assistant device may vary depending on the location and working arrangement of the order assistant. In some embodiments, the order assistant is located in a retail store (e.g., a restaurant), in which case the order assistant device may be a point-of-sale (POS) terminal of the retailer's POS system. In this case, the order assistant typically assists with order placement for the retail store, but not for any other companies. In other embodiments, the order assistant may work from home or may be located at a call center or other location that provides an Internet connection. In this case, the order assistant device may be any type of computing device capable of connecting to the Internet, such as a mobile phone, a personal computing tablet, a smart watch, a personal computer, or a laptop computer (i.e., the same types of devices as those used by the customer). It can be appreciated that, in these embodiments, the order assistant is not required to use a specialized device (such as a POS terminal) and may provide order assistance services on behalf of one or more companies, including one or more retail stores of a particular company. Alternatively, the order assistant device may be any computing device that uses AI technology to assist customers with placing orders as described herein.

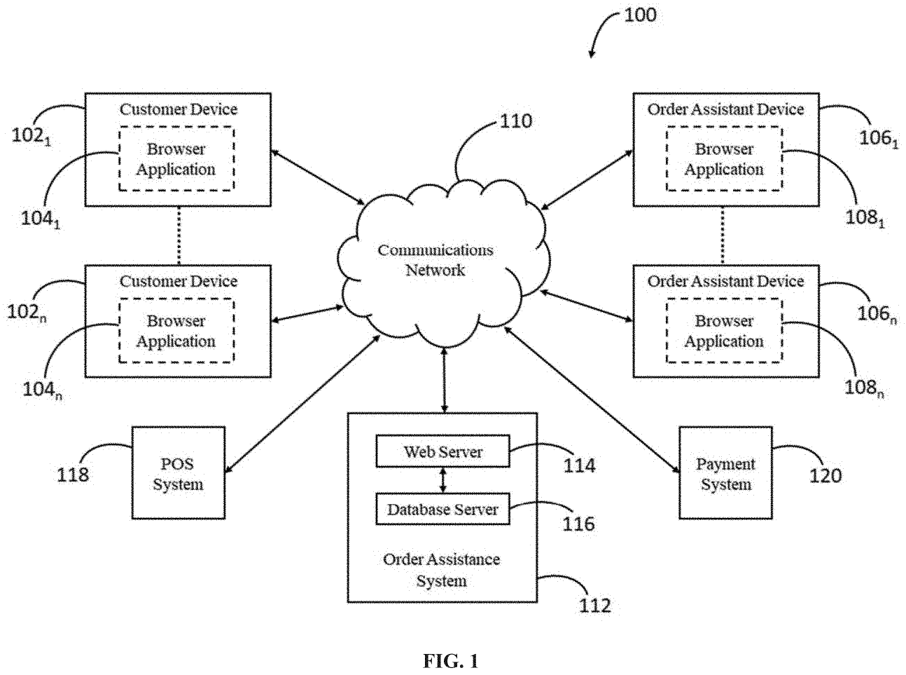

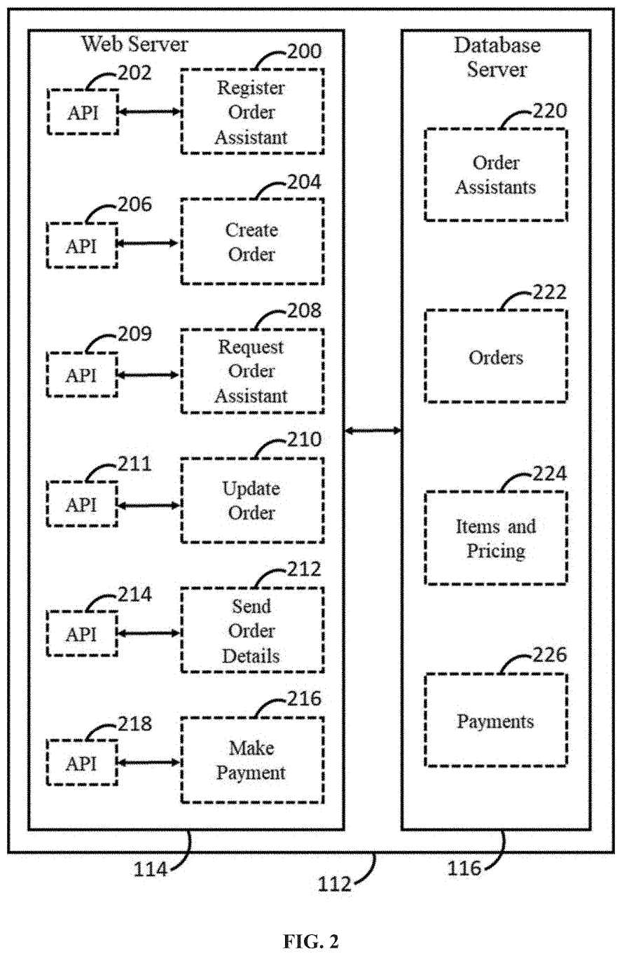

When placing an order, a customer may be able to order directly from a company's website or may have installed an application for placement of the order. In either scenario, the customer may wish to speak with an order assistant for assistance with the order. The user interface may have an option to speak with an order assistant or the customer may be automatically connected to an order assistant. Once the order session is initiated, the customer device is connected to the order assistant device through an order assistance system (such as order assistance system 112 shown in FIGS. 1 and 2, described below). During the order session, the customer and order assistant are able to have a live audio conversation on their respective devices without the need for either of the parties to dial a phone number. In addition, the customer and order assistant are able to create the customer's order via user interfaces presented on their respective devices. For example, the customer may verbally communicate the items that he or she would like to order to the order assistant, and the order assistant may add those items to the order via the user interface presented on the order assistant device. The order is then updated in real-time on the user interfaces presented on the customer device and the order assistant device. Thus, the order is always synchronized between the devices. Once the order is complete, the customer pays for the order via the user interface presented on the customer device using any online payment system. The order session is then closed to enable fulfillment of the order.

### Ordering System

Referring to FIG. 1, one embodiment of a system for providing real-time order assistance services to a plurality of customers is shown generally as reference number 100. System 100 includes a plurality of network elements—including customer devices 102₁-102ₙ, order assistant devices 106₁-106ₙ, an order assistance system 112, a POS system 118, and a payment system 120—which communicate with each other via a communications network 110, as described in greater detail below.

Each of customer devices 102₁-102ₙ is used by a customer to request assistance with placement of an order. As noted above, the customer device may be a mobile phone, an in-vehicle computer, a personal computing tablet, a smart watch, a personal computer, a laptop computer, or any other computing device that is capable of communication (wireless or wired) with other network elements via communications network 110. In this embodiment, each of customer devices 102₁-102ₙ utilizes an Internet-enabled application 104₁-104ₙ (e.g., a web browser or installed application) to communicate with web server 114, as described below.

Each of order assistant devices 106₁-106ₙ is used by an order assistant to provide order assistance services to a plurality of customers. As noted above, in cases where an order assistant is located in a retail store, the order assistant device used by that order assistant may be a POS terminal of a retailer's POS system (such as POS system 120 shown in FIG. 1). In cases where the order assistant works from home or is located at a call center or other location, the order assistant device used by that order assistant may be a mobile phone, a personal computing tablet, a smart watch, a personal computer, a laptop computer, or any other computing device that is capable of communication (wireless or wired) with other network elements via communications network 110. In this embodiment, each of order assistant devices 106₁-106ₙ utilizes an Internet-enabled application 108₁-108ₙ (e.g., a web browser or installed application) to communicate with web server 114, as described below. Alternatively, the order assistant device may be any computing device that uses AI technology to assist customers with placing orders as described herein.

Order assistance system 112 may comprise any suitable computer hardware known in the art that includes memory in data communication with at least one processor, wherein the memory stores at least one computer program comprising instructions that, when executed by the processor, cause the processor to perform the methods described herein. In this embodiment, order assistance system 112 includes a web server 114 in communication with a database server 116.

Web server 114 is accessible by customer devices 102₁-102ₙ and order assistant devices 106₁-106ₙ via communications network 110. Specifically, the Internet-enabled application of each customer device sends requests to web server 114, and web server 114 responds by providing data that enables the Internet-enabled application to display various user interfaces on the customer device, as described below. Similarly, the Internet-enabled application of each order assistant device sends requests to web server 114, and web server 114 responds by providing a user interface that enables the Internet-enabled application to display various web pages on the order assistant device, as described below. Web server 114 may communicate with customer devices 102₁-102ₙ and order assistant devices 106₁-106ₙ via Hypertext Transfer Protocol (HTTP) (e.g., HTTP/1.0, HTTP/1.1 plus, HTTP/2, or HTTP/3), Hypertext Transfer Protocol Secure (HTTPS), or any other network protocol used to distribute data and web pages.

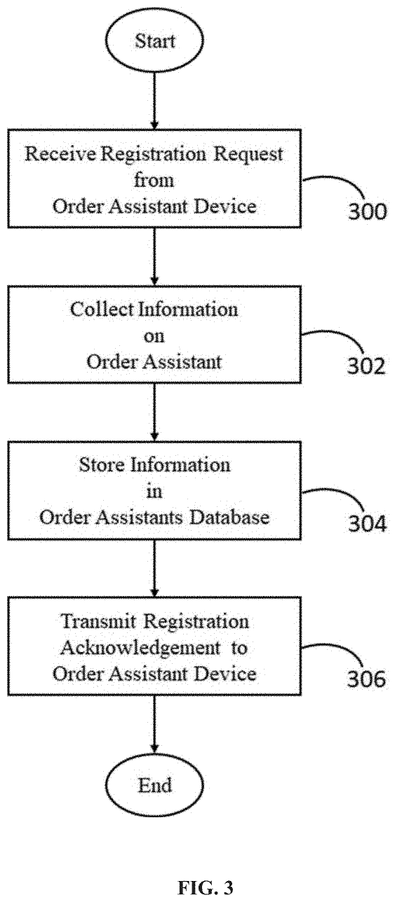

As shown in FIG. 2, web server 114 provides access to a number of different applications through application programming interfaces (APIs), including: a Register Order Assistants application 200 that is accessible through API 202; a Create Order application 204 that is accessible through API 206; an Update Order application 210 that is accessible through API 211; a Send Order Details application 212 that is accessible through API 214; and a Make Payment application 216 that is accessible through API 218. The functionality provided by these applications will be described below in connection with the process flow charts of FIGS. 3-9.

It will be seen that web server 114 establishes two connections—a data connection and an audio connection—between one of customer devices 102₁-102ₙ and one of order assistant devices 106₁-106ₙ during an order session. The data connection may comprise any type of connection that enables creation of the customer's order, such as a WebSocket connection or a Web Real-Time Communication (WebRTC) connection. The audio connection may comprise any type of connection that enables audio (i.e., audio only or audio/video) communication between the customer device and the order assistant device, such as a WebRTC connection, a Bluetooth connection, an Ultra-Wideband (UWB) connection, or a Voice over Internet Protocol (VoIP) connection. Of course, other network protocols may be used to establish these connections within the scope of the present invention.

Referring again to FIG. 2, database server 116 maintains a number of different databases to store data collected by web server 114, including: an Order Assistants database 220; an Orders database 222; an Items and Pricing database 224; and a Payments database 226. It should be understood that web server 114 controls the storage of data to and the retrieval of data from database server 116.

In this embodiment, web server 114 and database server 116 are co-located in the same geographic location. It should be understood, however, that these servers could be located in different geographic locations and connected to each other via communications network 110. It should also be understood that other embodiments may not include both of the servers shown in FIG. 1, e.g., web server 114 could be used to maintain the databases such that database server 116 is not required. Further, other embodiments may include additional servers that are not shown in FIG. 1, e.g., the applications could be stored on a separate application server and/or the APIs could be stored on a separate API server. Thus, the system may be implemented with any number and combination of servers, including web servers, application servers, API servers, and database servers, which are either co-located or geographically dispersed.

Referring back to FIG. 1, POS system 118 comprises a POS system (either a cloud-based POS server or a legacy POS system) of a restaurant or other retail store. POS system 118 transmits item and pricing data (e.g., a menu of the items available for order from the retail store along with the pricing of the items) to order assistance system 112 for storage in Items and Pricing database 224. If POS system 118 comprises a cloud-based POS server with POS terminals connected thereto, the POS server will typically expose an API that may be called by order assistance system 112 to retrieve the item and pricing data on a periodic basis. If POS system 108 is a legacy POS system located inside a retail store, the POS system will typically not have an API. In this case, an API generator or other software program may be installed on the POS system to connect the POS system's database to Items and Pricing database 224 to enable the retrieval of the item and pricing data on a periodic basis. Thus, Items and Pricing database 224 is synchronized with POS system 118 to provide current item and pricing information to customer devices 102₁-102ₙ and order assistant devices 106₁-106ₙ, as described below. While only one POS system 118 is shown in FIG. 1, it should be understood that system 100 will include a POS system for each retail store that receives order assistance services through system 100.

Referring still to FIG. 1, payment system 120 comprises any online payment system capable of processing payments for the orders created by order assistance system 112. Examples of payment options include automated clearing house (ACH), electronic check, credit card, debit card, Apple Pay®, Google Pay®, Amazon Pay™, PayPal®, Zelle®, Venmo®, or cryptocurrency. Of course, other types of payment options are possible and within the scope of the present invention.

Communications network 110 may comprise any network capable of facilitating the exchange of data among the network elements of system 100, such as those that operate according to the IEEE 802.3 protocol (e.g., Ethernet) and/or the IEEE 802.11 protocol (e.g., Wi-Fi). The communications infrastructure may comprise any medium that allows data to be physically transferred through serial or parallel communication channels (e.g., wireless communication channels, cellular communications, optical fiber, copper wire, etc.). It can be appreciated that communications network 110 will typically comprise the Internet so as to enable access to order assistance system 112 by any Internet-enabled device.

### Ordering Methods

As discussed above, system 100 shown in FIG. 1 may be used to provide real-time order assistance services to a plurality of customers. Various examples of the methods embodied in system 100, and particularly order assistance system 112 (shown in FIG. 2), will now be described with reference to the process flow charts of FIGS. 3-9.

Referring to FIG. 3, an exemplary method for registering order assistants in accordance with one embodiment of the present invention is described with reference to steps 300-306.

In step 300, web server 114 receives a registration request from an order assistant device of order assistant (or another computing device being used by the order assistant to complete the registration process). In one embodiment, the order assistant accesses an order registration website on the order assistant device and selects a button that makes a call to a Uniform Resource Locator (URL) associated with web server 114 (e.g., http://myserver.com/Registration). When the URL is received at web server 114, it calls the Register Order Assistant application 200 via API 202. The Register Order Assistant application 200 generates and returns a web page with a user interface that allows the user to enter registration information on the order assistant device. The information collected during the registration process is used to identify the order assistant and may include, for example, data such as Name, Email Address, Employee Id, Username and Password. In step 302, web server 114 collects the registration information for the order assistant and, in step 304, stores the collected information in Order Assistants database 220 on database server 116. Then, in step 306, web server 114 returns a registration acknowledgement via API 202 that is presented on the order assistant device. It can be appreciated that this process is repeated for each order assistant who provides order assistance services through system 100.

Of course, in some embodiments, the registration of order assistants could be performed by a human resources manager or other company personnel who performs the registration process on behalf of a plurality of order assistants. In other embodiments, the order assistant information is downloaded from a company database to Order Assistants database 220, in which the case the method shown in FIG. 3 would not be required.

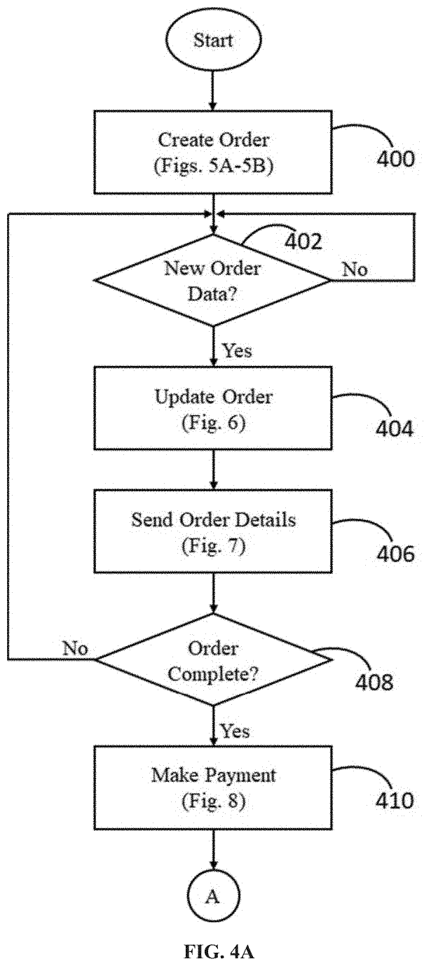

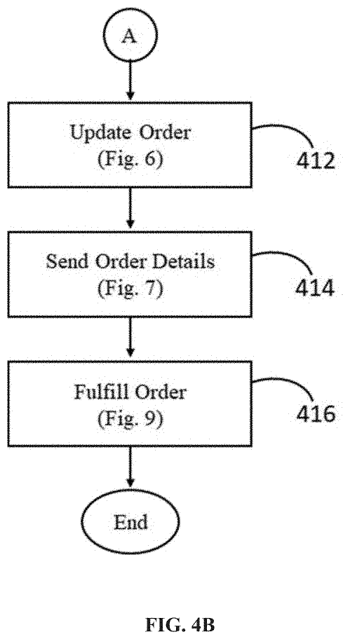

Referring to FIGS. 4A-4B, an exemplary method for enabling a customer to place an order with the assistance of an order assistant in accordance with one embodiment of the present invention is described with reference to steps 400-416.

In step 400, web server 114 creates an order session between the customer device and the order assistant device in response to receipt of an initial order request from the customer device. In order to create the order session, web server 114 establishes an audio connection and a data connection between the customer device and the order assistant device. The audio connection enables real-time audio communication between the customer and the order assistant during the order session. The data connection enables the customer and order assistant to create (i.e., view and optionally update) an order in real-time during the order session. An example of these connections is shown in FIG. 10, wherein a customer device 1000 of a customer 1002 is connected to an order assistant device 1004 of an order assistant 1006 via a web server located on the Internet 1008. As can be seen, the web server establishes a real-time audio connection 1010 with customer device 1000 and a real-time audio connection 1012 with order assistant device 1004 to create the audio connection between the devices. Similarly, the web server establishes a real-time data connection 1014 with customer device 1000 and a real-time data connection 1016 with order assistant device 1004 to create the data connection between the devices. It should be noted that web server 114 will also establish a data connection with POS system 118 if the order assistant device is not a POS terminal of POS system 118, in which case there will be three devices on the data connection, i.e., the customer device, the order assistant device, and POS system 118.

Referring back to FIGS. 4A-4B, once the order session is created, it is determined in step 402 whether any new order data has been entered by the order assistant device during creation of the customer's order (or possibly by the customer device if the customer is allowed to make changes to the order). If not, then the process returns to step 402 to look for new order data. If new order data has been entered, then the order is updated to include the new order data in step 404. In step 406, the updated order is transmitted to the customer device and the order assistant device to ensure that the customer and order assistant are able to view the same order on their respective devices during the order session. Web server 114 may also transmit the updated order to POS system 118 if the order assistant device is not a POS terminal of POS system 118.

In step 408, it is determined whether the order is complete. If not, then the process returns to step 402 to look for new order data. If the order is complete, then the customer uses the customer device to submit payment data in step 410. Upon receipt of the payment data, web server 114 transmits the payment data to payment system 120 for further processing. Payment system then returns either a payment authorization or a payment denial to web server 114. In step 412, web server 114 updates the order to include the payment status. In step 414, the order's payment status is transmitted to the customer device and the order assistant device to ensure that the customer and order assistant are able to view the same payment status on their respective devices during the order session. Web server 114 may also transmit the order's payment status to POS system 118 if the order assistant device is not a POS terminal of POS system 118. Finally, in step 416, the order session is closed to enable fulfillment of the order via POS system 118.

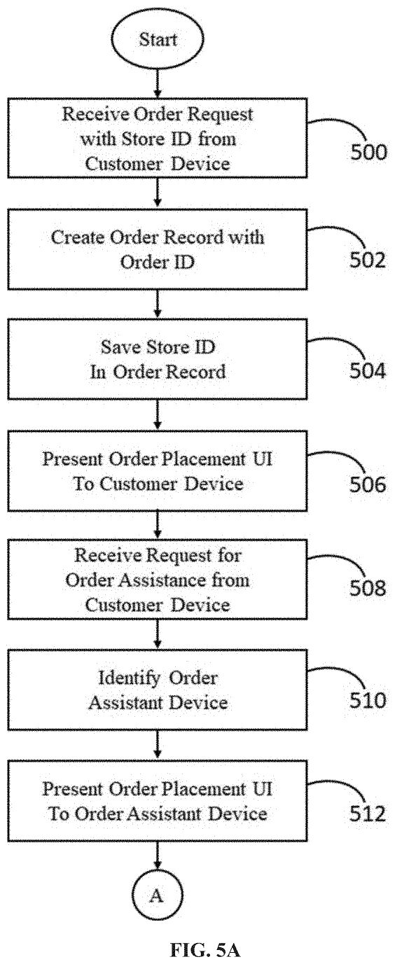

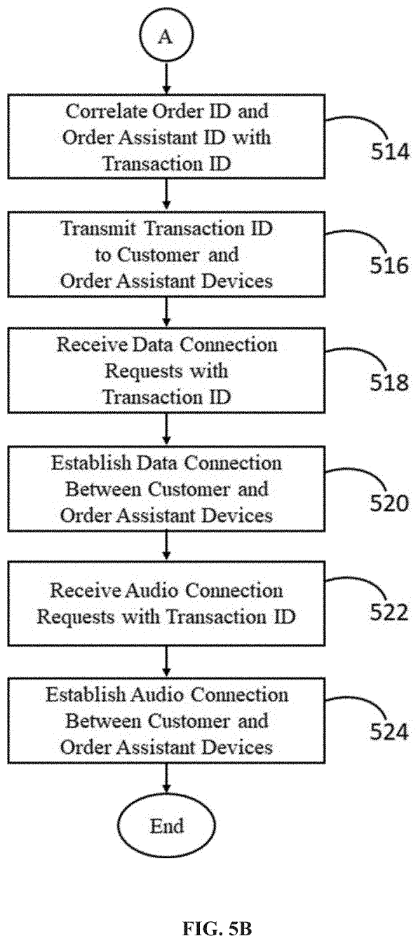

Referring to FIGS. 5A-5B, an exemplary method for creating an order session between the customer device and the order assistant device in accordance with one embodiment of the present invention is described with reference to steps 500-524. It should be understood that this embodiment may be used as step 400 of the method shown in FIGS. 4A-4B.

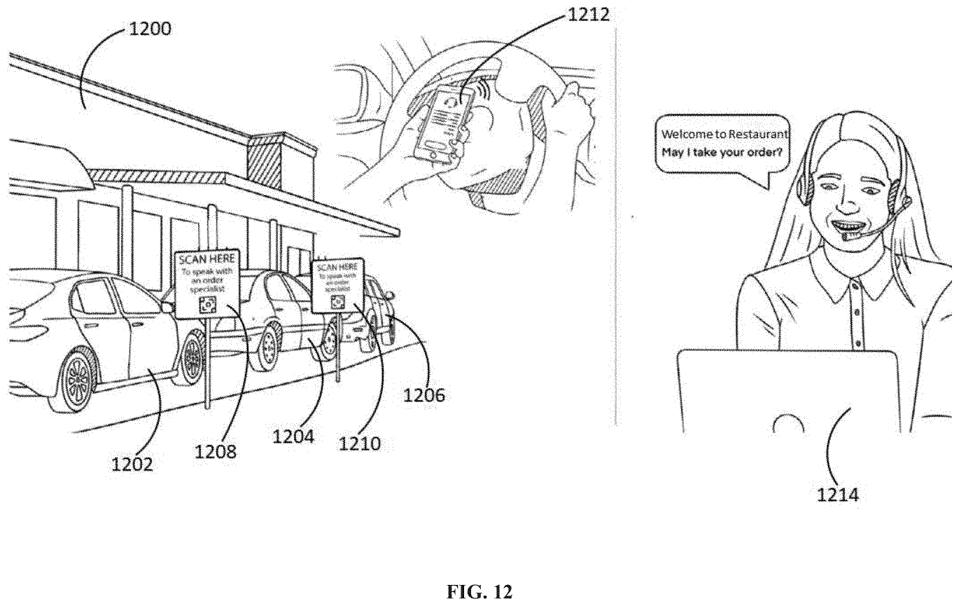

In step 500, web server 114 receives an initial order request from the customer device. The customer may use the customer device to initiate the order session in a variety of different ways, such as scanning a Quick Response (QR) code or other type of bar code with the customer device, tapping or placing the customer device near a Near-Field Communication (NFC) tag or Bluetooth device, sending a text message from the customer device, opening an application on the customer device, or clicking a button or notification on a website displayed on the customer device. Examples of these initiation methods are described in greater detail below in connection with the exemplary implementations shown in FIGS. 12-15.

The initial order request is directed to a URL associated with web server 114 ((e.g., http://myserver.com/CreateOrder) and may include a store identifier that identifies the retail store from which the customer wishes to place an order. For example, the customer may initiate the order session by scanning a QR code that encodes the URL and store identifier, in which case the customer device will open its Internet-enabled application and provide the store identifier to that URL. The store identifier will typically be assigned to the retail store ahead of time, e.g. when the retail store is added to system 100 and the item and pricing information is downloaded to Items and Pricing database 224. Of course, if system 100 is only used to provide order assistance services to a single retail store, then the store identifier would not be required.

When the URL is received at web server 114, it calls the Create Order application 204 via API 206. The Create Order application 204 performs a number of functions. First, in step 502, a new order record is inserted into Orders database 222 and a new order identifier is assigned to the order record. The order record includes a number of data fields, as shown in Table 1 below:

TABLE 1

| Data Field | Field Description |
|---|---|
| order_id | order identifier |
| order_status | status of the order (open, paid, |
| | closed, picked up, cancelled, etc.) |
| order_dates | relevant dates of order (date opened, |
| | date last updated, date paid, pate |
| | picked up, date closed, etc.) |
| order_items | a list of items and prices |
| order_discounts | discount applied to the order (if any) |
| order_service_charge | service charge applied to the order |
| | (if any) |
| payment_status | payment status for the order |
| | (authorized or denied) |

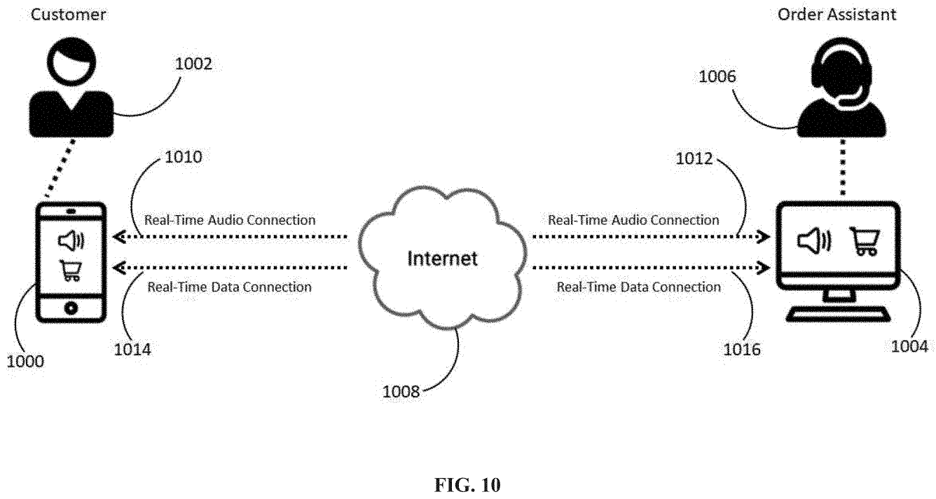

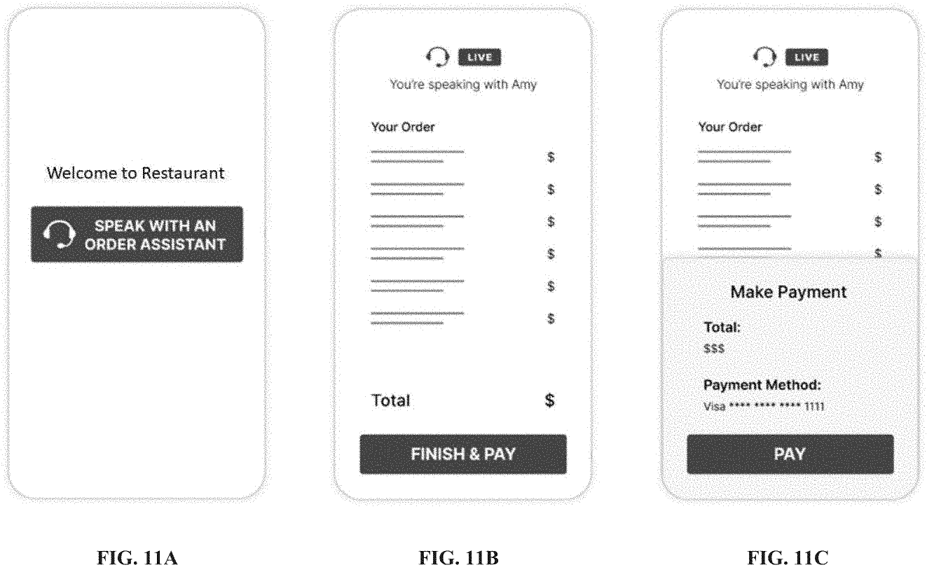

Next, in step 504, the received store identifier is stored in the order record. Then, in step 506, a web page with a user interface that allows placement of an order is generated and returned to the customer device via API 206. The web page includes the items and pricing for the retail store having the received store identifier as retrieved from the Items and Pricing database 224. The web page also includes a “Speak with an Order Assistant” button that can be selected to request order assistance. An exemplary screen shot of a web page with this button is shown in FIG. 11A, wherein the items and pricing are not shown for ease of illustration. Selection of the “Speak with an Order Assistant” button makes another call to a URL associated with web server 114 (e.g., http://myserver.com/RequestAssistance).

Web server 114 stores a user interface layout that is used to generate the web page presented on the customer device, i.e., the user interface layout has a predetermined format that allows the inclusion of dynamic values, such as the items and pricing for a particular retail store. In this embodiment, the same user interface layout is used in connection with all of the retail stores that receive order assistance services through system 100 and, as such, the user interface will have the same “look and feel” for all of the retail stores. This will provide a consistent user experience in the event that a customer places orders at more than one retail store. In some embodiments, the user interface may have features that can be turned on and off in accordance with the preference of each retail store. For example, some retail stores may want customers to be able to both view and edit their order, while others may only want viewing rights for the customers (in which case only the order assistants would have editing rights). Of course, in other embodiments, web server 114 may store more than one user interface layout for the customer devices that can be used with different retail stores.

In step 508, when the URL is received at web server 114, it calls the Request Order Assistant application 208 via API 209. In step 510, the Order Assistants database 220 is queried to identify an order assistant that is currently available for assignment to the order, wherein the order assistant is associated with an order assistant identifier. Once an available order assistant has been identified, a notification is transmitted to the order assistant device associated with the order assistant identifier of the identified order assistant, which prompts the order assistant to confirm that he/she is available to provide order assistance to the customer. For example, the order assistant may select an “Accept Request” button that can be selected by the order assistant to accept the request to provide order assistance. Selection of the “Accept Request” button makes a call to a URL associated with web server 114 (e.g., http://myserver.com/AcceptRequest), whereby the order assistant device and the customer device are connected with each other. Next, in step 512, a web page with a user interface that allows placement of an order is generated and transmitted to the order assistant device via API 206. The web page includes the items and pricing associated with the store identifier contained in the order record as retrieved from the Items and Pricing database 224.

Web server 114 stores another user interface layout that is used to generate the web page presented on the order assistant device, i.e., the user interface layout has a predetermined format that allows the inclusion of dynamic values, such as the items and pricing for a particular retail store (similar to the user interface layout for the customer device). In this embodiment, the same user interface layout is used in connection with all of the retail stores that receive order assistance services through system 100 and, as such, the user interface will have the same “look and feel” for all of the retail stores. This will simplify the training process for order assistants (i.e., they will only have to learn a single system). Of course, in other embodiments, web server 114 may store more than one user interface layout for the order assistant devices that can be used with different retail stores.

It should be understood that the user interface layout for the customer device may be the same as or different from the user interface layout for the order assistant device. In some embodiments, the user interface layout for the customer device provides a simple user experience for placing an order, while the user interface layout for the order assistant device provides more advanced features for order placement. Of course, in other embodiments, the user interfaces for both devices are the same or similar.

In step 514, the order identifier and the order assistant identifier are correlated using a transaction identifier. In one embodiment, a record that includes the transaction identifier, the order identifier, and the order assistant identifier are part of a record inserted into a table (e.g., Transaction [transaction_id, order_id, order_assistant_id]). In step 516, the transaction identifier is returned back to the customer device via API 206 in response to the customer's selection of the “Speak with an Order Assistant” button and, similarly, the transaction identifier is returned back to the order assistant device via API 206 in response to the order assistant's selection of the “Accept Request” button. It will be seen that the customer device and the order assistant device both use the transaction identifier to identify themselves to web server 114 during an order session so as to enable the establishment of various connections between the devices.

Of course, it should be understood that the present invention is not limited to the use of a separate transaction identifier to correlate the order identifier and the order specialist identifier. In some embodiments, the order identifier may function as the transaction identifier if the order assistant identifier is stored in the order record. In this case, the order identifier is correlated with the order specialist identifier by virtue of them both being stored in the order record. Other types of transaction identifiers may also be used within the scope of the present invention.

Upon receipt of the transaction identifier, the customer device and the order assistant device each send two connection requests to web server 114—a data connection request and an audio connection request. Alternatively, a single connection request may be made in which data and audio are transmitted on the same connection.

In order to make the data connection request, the user interface of the customer device and the user interface of the order assistant device each make a first call to a URL associated with web server 114, wherein the URL references the transaction identifier. It should be noted that both devices may call the same URL. In this embodiment, each of the calls comprises a Web Socket call (e.g., wss://myserver.com/data/transaction=transaction_id). Of course, other network protocols that enable the creation of a point-to-point data connection could also be used within the scope of the present invention.

In order to make the audio connection request, the user interface of the customer device and the user interface of the order assistant device each make a second call to a URL associated with web server 114, wherein the URL references the transaction identifier. Again, it should be noted that both devices may call the same URL. In this embodiment, each of the calls comprises a WebRTC call (e.g., wss://myserver.com/audio/transaction=transaction_id). Of course, other network protocols that enable the creation of a point-to-point audio connection could also be used within the scope of the present invention.

In some embodiments, the data and audio connection requests may both comprise WebRTC calls. In this case, the customer device and the order assistant device each use a single URL to establish a connection containing both the audio and data in combination.

In step 518, web server 114 receives the data connection request from each of the customer device and the order assistant device and, in step 520, uses the transaction identifier to establish a data connection between the devices. It will be seen that the data connection enables the customer and order assistant to create (i.e., view and optionally update) an order in real-time during the order session. It should be noted that web server 114 will also establish a data connection with POS system 118 if the order assistant device is not a POS terminal of POS system 118, in which case there will be three devices on the data connection, i.e., the customer device, the order assistant device, and POS system 118.

In step 522, web server 114 receives the audio connection request from each of the customer device and the order assistant device and, in step 524, uses the transaction identifier to establish an audio connection between the devices. It will be seen that the audio connection enables real-time audio communication between the customer and the order assistant during the order session.

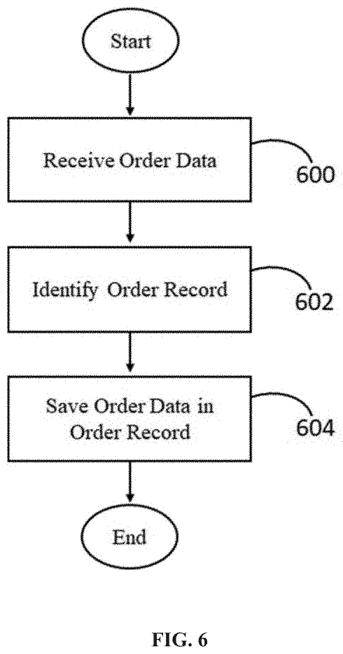

Referring to FIG. 6, an exemplary method for updating an order during an order session in accordance with one embodiment of the present invention is described with reference to steps 600-604. It should be understood that this embodiment may be used as step 404 and step 412 of the method shown in FIGS. 4A-4B.

In step 600, web server 114 receives order data during the order session. In some cases, the order data comprises order-related information received in step 404 of the method shown in FIGS. 4A-4B, such as an item added to an order, an item removed from an order, a discount applied, or other information received from either the customer device or the order assistant device via the data connection. In this embodiment, the customer and/or order assistant would enter this order data via their respective user interfaces while placing an order. Upon entry of the order data, the user interface makes a call to a URL associated with web server 114 (e.g., http://myserver.com/UpdateOrder). When the URL is received at web server 114, it calls the Update Order application 210 via API 211. Of course, in other cases, the order data comprises payment-related information received in step 412 of the method shown in FIGS. 4A-4B, such as the status of the payment (e.g., payment authorized or payment denied). For this order data, the Update Order Application 210 is called by the Make Payment application 216 (described below).

For all types of order data, the Update Order application 210 performs a number of functions. First, in step 602, the transaction identifier associated with the received order data is used to determine the order identifier, and then the Orders database 222 is queried to identify the order record associated with the order identifier. Then, in step 604, the order data is stored in the order record. In this embodiment, the order data is used to update the data fields of the order record shown in Table 1 above. For example, when an item is added to or removed from an order, there will be an update to both the order_dates and order_items data fields. Also, when the payment status is changed, there will be an update to the payment_status data field. Other updates to the data fields shown in Table 1 will be apparent to one skilled in the art.

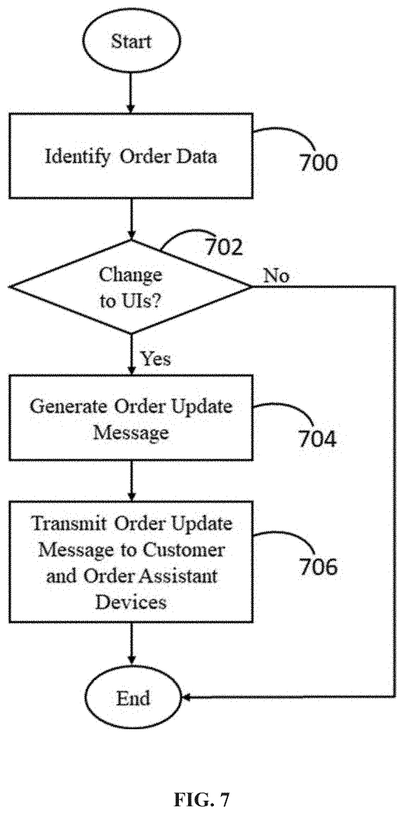

Referring to FIG. 7, an exemplary method for sending order details during an order session in accordance with one embodiment of the present invention is described with reference to steps 700-706. It should be understood that this embodiment may be used as step 406 and step 414 of the method shown in FIGS. 4A-4B.

In this embodiment, steps 700-706 are performed by Send Order Details application 212, which is triggered whenever new order data is stored in the order record via the function of the Update Order application 210. In step 700, the new order data is identified and, in step 702, it is determined whether the new order data causes a change to one or both of the user interfaces of the customer and order assistant devices. If not, the process ends. This may occur, for example, when the order is picked up. If the new order data causes a change to one or both of the user interfaces, then an order update message is generated in step 704. In step 706, API 214 returns the order update message to one or both of the customer device and the order assistant device over the data connection, as applicable, wherein the device updates its user interface with the new information. Thus, the order may be updated in real-time on the user interfaces of the customer device and the order assistant device so that the order is always synchronized between the devices. Web server 114 may also transmit the order update message to POS system 118 over the data connection if the order assistant device is not a POS terminal of POS system 118.

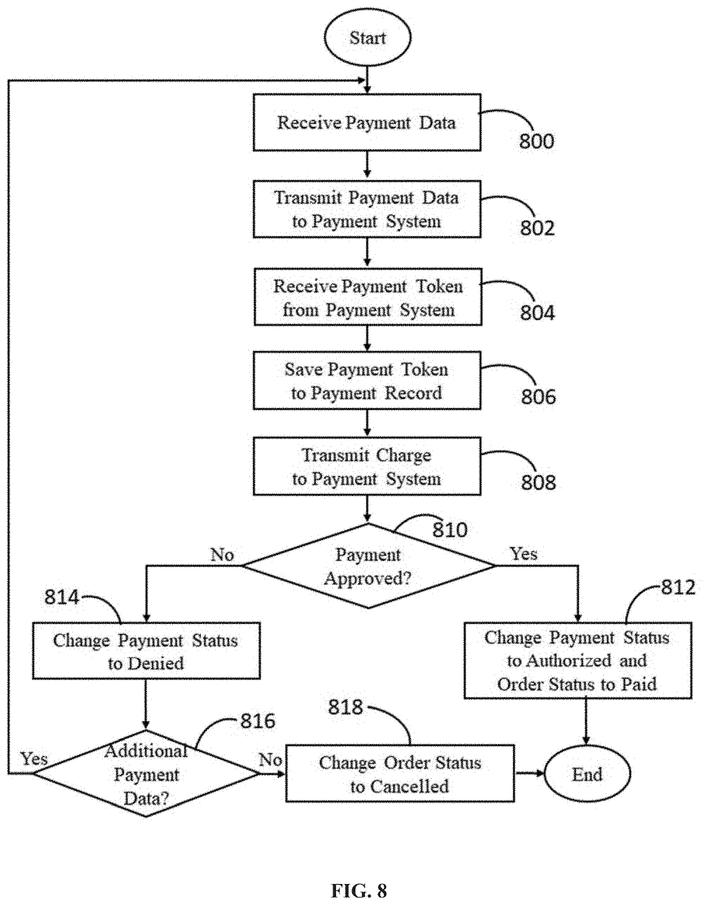

Referring to FIG. 8, an exemplary method for making a payment during an order session in accordance with one embodiment of the present invention is described with reference to steps 800-814. It should be understood that this embodiment may be used as step 410 of the method shown in FIGS. 4A-4B.

The user interface of the customer device includes a “Finish & Pay” button that can be selected by the customer when the order is complete. An exemplary screen shot of a web page with this button is shown in FIG. 11B. Selection of the “Finish & Pay” causes the user interface to present a payment form to enable the customer to enter payment data. For example, if the payment method is a credit or debit card, the payment data will include the credit card number, expiration date, and Card Verification Value (CCV) number. Of course, other payment methods will include other types of payment data. The user interface also presents a “Pay” button that can be selected by the customer when all of the payment data has been entered. An exemplary screen shot of a web page with this button is shown in FIG. 11C. Selection of the “Pay” button makes a call to a URL associated with web server 114 (e.g., http://myserver.com/MakePayment). Of course, in other embodiments, the user interface of the order assistant device also includes the payment features described herein (e.g., the “Finish & Pay” button and the “Pay” button), which enables the order assistant to collect the payment information from the customer and complete the payment.

When the URL is received at web server 114, it calls the Make Payment application 216 via API 218. The Make Payment application 216 performs a number of functions. First, in step 800, the payment data is received and, in step 812, the payment data is transmitted to the API of payment system 120. In step 804, a payment token is received from the API of payment system 120. In step 806, a new payment record is inserted into Payments database 226 and the payment token is stored in the payment record so the customer can re-use that payment method in the future. The payment token is also stored on the customer device to enable use of the payment token in connection with future orders made via system 100.

In step 808, the payment token along with the total charge of the order is transmitted to the API of payment system 120. In step 810, when the response is received from the API of payment system 120, it is determined whether the payment was approved. If so, in step 812, the “Update Order” application 210 is called to change the payment_status to “authorized” and the order status to “paid” in the order record. This information is then returned to the customer device and the order assistant device (and POS System 118 if the order assistant device is not a POS terminal) via the Send Order Details application 212, as described above.

If the payment was not approved, in step 814, the “Update Order” application 210 is called to change the payment status to “denied” in the order record. This information is then returned to the customer device and the order assistant device (and POS System 118 if the order assistant device is not a POS terminal) via the Send Order Details application 212, as described above. In step 816, it is determined whether the customer entered additional payment data. If so, the process returns to step 800 to repeat the process. Otherwise, in step 818, the order status is changed to “cancelled” in the order record.

It should be noted that web server 114 terminates the audio and data connections between the customer device and the order assistant device once the communications between the customer and order assistant have ended.

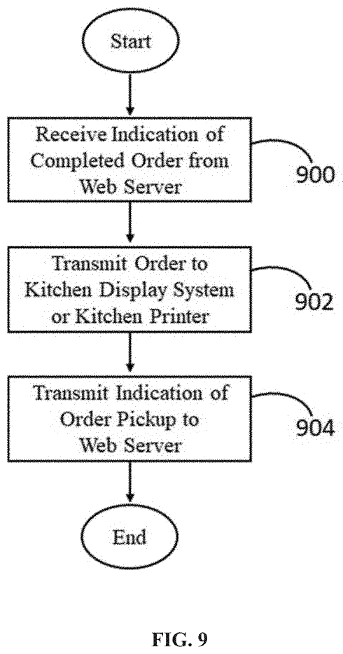

Referring to FIG. 9, an exemplary method for fulfilling an order when the order session is closed in accordance with one embodiment of the present invention is described with reference to steps 900-904. It should be understood that this embodiment may be used as step 416 of the method shown in FIGS. 4A-4B.

In step 900, when the order status is changed to “paid,” this information is received by POS system 118 via the Send Order Details application 212 of web server 114. In this embodiment, this change in the order status provides an indication that the order is complete and ready for fulfillment. In step 902, POS system 118 transmits the order details to enable fulfillment of the completed order. For example, if the retail store is a restaurant, the order details (e.g., the order items and an indication of payment, such as the last four digits of the credit or debit card number) may be displayed on a kitchen display screen (KDS) and/or automatically printed by a kitchen printer to enable the staff to start preparing the order. Of course, in other embodiments, the retail store may begin fulfillment of the order prior to completion of the payment process. In step 904, POS system 118 transmits an indication that the order has been picked up to web server 114, at which point the order status is changed to “picked up.” When the order and payment process is complete, the order status may be changed to “complete,” “closed,” or fulfilled,” depending on the process used by the business.

Referring to FIGS. 12-15, it should be understood that system 100 shown in FIG. 1 (and particularly order assistance system 112 shown in FIG. 2) may be used in a variety of different implementations.

In the implementation shown in FIG. 12, the system enables the provision of order assistance services to customers in a drive-through line of a restaurant 1200, such as the customers in vehicles 1202, 1204, and 1206. A customer may initiate an order session using the customer device 1212, such as by scanning a QR code displayed on signage 1208 and 1210 or a digital display. When the customer scans the QR code, customer device 1212 is connected over the Internet to an order assistant device 1214 of an order assistant. The customer and order assistant may then have a live audio conversation while the order is being placed on their respective devices. For example, the customer may tell the order assistant what he or she would like to order, and the order assistant adds items to the order using order assistant device 1214. The order is then updated in real-time on both customer device 1212 and order assistant device 1214. If order assistant device 1214 is not located within restaurant 1200 (e.g., if the order assistant works from home or is located at a call center), the order is also transmitted to a POS system so that on-site staff can quickly fulfill the order and provide it to the customer.

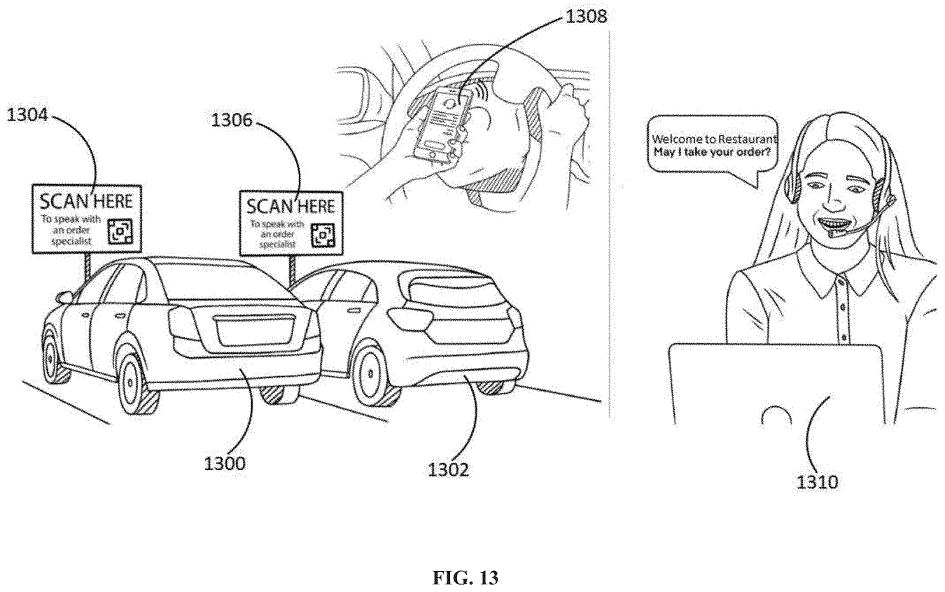

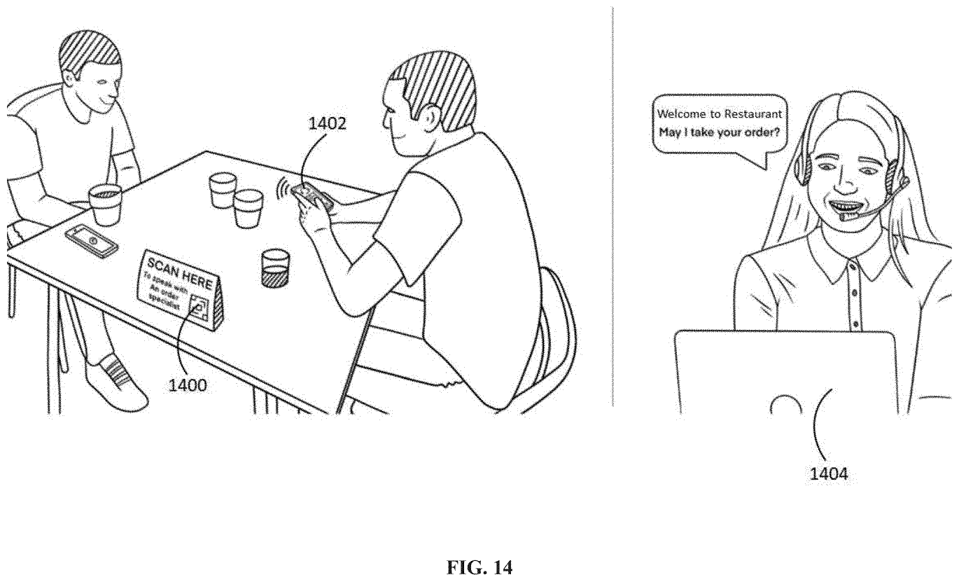

In the implementation shown in FIG. 13, the system enables the provision of order assistance services to customers parked in a parking lot of a restaurant, such as the customers in vehicles 1300 and 1302. A customer may initiate an order session using the customer device 1308, such as by scanning a QR code displayed on signage 1304 and 1306 or a digital display. When the customer scans the QR code, customer device 1308 is connected over the Internet to an order assistant device 1310 of an order assistant. The customer and order assistant may then have a live audio conversation while the order is being placed on their respective devices. For example, the customer may tell the order assistant what he or she would like to order, and the order assistant adds items to the order using order assistant device 1310. The order is then updated in real-time on both customer device 1308 and order assistant device 1310. If order assistant device 1310 is not located within the restaurant (e.g., if the order assistant works from home or is located at a call center), the order is also transmitted to a POS system so that on-site staff can quickly fulfill the order and provide it to the customer.

It should be understood that the implementation shown in FIGS. 12 and 13 enable multiple customers to place their orders at the exact same time. For example, if a restaurant has six vehicles in its drive-through line and five vehicles in its parking lot, it would be possible for the restaurant to take all eleven orders at the exact same time, providing a much faster and efficient service for its customers compared to conventional ordering systems.

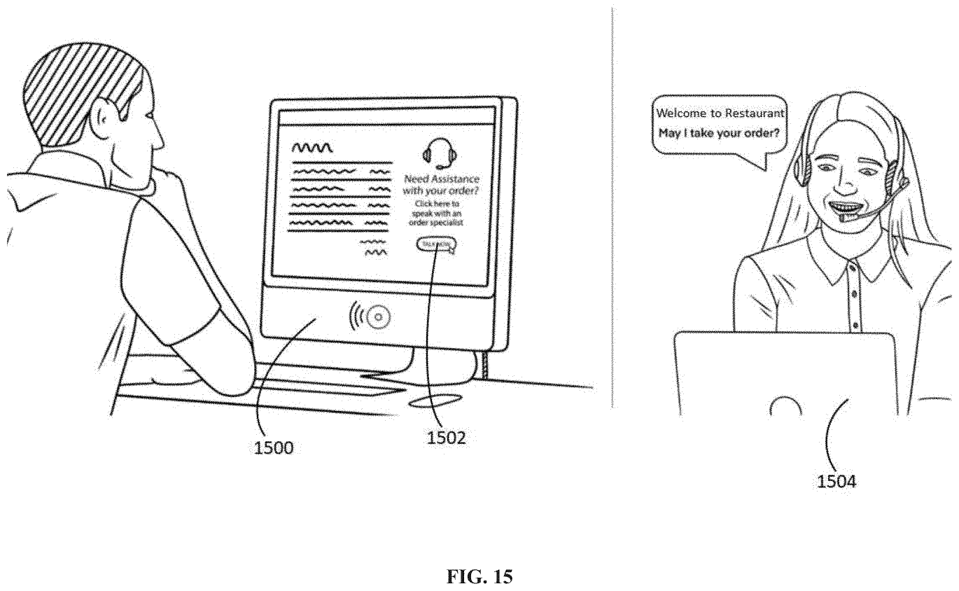

In the implementation shown in FIG. 14, the system enables the provision of order assistance services to customers inside a retail store, such as customers sitting at tables or located within a designated ordering area of a restaurant. A customer may initiate an order session using the customer device 1402, such as by scanning a QR code displayed on signage 1400 located on the table. When the customer scans the QR code, customer device 1402 is connected over the Internet to an order assistant device 1404 of an order assistant. The customer and order assistant may then have a live audio conversation while the order is being placed on their respective devices. For example, the customer may tell the order assistant what he or she would like to order, and the order assistant adds items to the order using order assistant device 1404. The order is then updated in real-time on both customer device 1402 and order assistant device 1404. If order assistant device 1404 is not located within the restaurant (e.g., if the order assistant works from home or is located at a call center), the order is also transmitted to a POS system so that on-site staff can quickly fulfill the order and provide it to the customer.

In the implementation shown in FIG. 15, the system enables the provision of order assistance services to customers visiting a website (wherein the website is a restaurant's website in this implementation). A customer may initiate an order session using the customer device 1500 by selecting an action button 1502 (e.g., “Talk Now”) displayed on a website. When the customer selects the action button, customer device 1500 is connected over the Internet to an order assistant device 1504 of an order assistant. The customer and order assistant may then have a live audio conversation while the order is being placed on their respective devices. For example, the customer may tell the order assistant what he or she would like to order, and the order assistant adds items to the order using order assistant device 1504. The order is then updated in real-time on both customer device 1500 and order assistant device 1504. If order assistant device 1504 is not located within the physical store (e.g., if the order assistant works from home or is located at a call center), the order is also transmitted to a POS system so that on-site staff can quickly fulfill the order for subsequent pickup by the customer.

It should be understood that the implementations shown in FIGS. 12-15 are merely examples and that system 100 is not limited to the provision of order assistance services to restaurants. For example, the website implementation shown in FIG. 15 may be used in connection with the placement of orders for a variety of different products and services, e.g., the order assistant may be placing items in a shopping cart on any website. Also, instead of a website, the order assistance services may be provided to customers who have accessed an application installed on their customer devices. This application may detect that a customer is located at a specific retail location that offers order assistance services, and the customer device may prompt the customer to place an order by requesting order assistance. Of course, other implementations are also possible within the scope of the present invention.

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

The use of relative relational terms, such as first and second, are used solely to distinguish one unit or action from another unit or action without necessarily requiring or implying any actual such relationship or order between such units or actions.

Finally, while the present invention has been described and illustrated hereinabove with reference to various exemplary embodiments, it should be understood that various modifications could be made to these embodiments without departing from the scope of the invention. Therefore, the present invention is not to be limited to the specific systems or methodologies of the exemplary embodiments, except insofar as such limitations are included in the following claims.

What is claimed and desired to be secured by Letters Patent is as follows:

1. An order assistance system, comprising:
a processor;
a memory in data communication with the processor, the memory storing at least one computer program comprising instructions that, when executed by the processor, cause the processor to perform a plurality of operations comprising:
receiving an initial order request from a customer device of a customer and, in response, providing a first user interface for rendering by a first Internet-enabled application of the customer device, wherein the first user interface enables selection of a request for order assistance;
receiving the request for order assistance from the customer device and, in response, identifying an order assistant device of an order assistant available to assist with the request for order assistance, and providing a second user interface for rendering by a second Internet-enabled application of the order assistant device;
transmitting a transaction identifier to each of the customer device and the order assistant device, wherein the first and second user interfaces each utilize the transaction identifier to transmit a plurality of connection requests;
receiving the connection requests from the customer device and the order assistant device and, in response, establishing an audio connection and a data connection between the customer device and the order assistant device;
managing an order session by (a) enabling audio communication between the customer and the order assistant via the audio connection and (b) enabling the customer and the order assistant to create an order via the data connection; and
closing the order session when the order is complete to enable fulfillment of the order.

2. The order assistance system of claim 1, wherein the customer device comprises one of a mobile phone, an in-vehicle computer, a personal computing tablet, a smart watch, a personal computer, or a laptop computer.

3. The order assistance system of claim 1, wherein the order assistant device comprises one of a mobile phone, a personal computing tablet, a smart watch, a personal computer, a laptop computer, or a point-of-sale terminal.

4. The order assistance system of claim 1, wherein the customer device is configured to decode a Uniform Resource Locator (URL) from a barcode, and wherein the first Internet-enabled application of the customer device uses the URL to transmit the initial order request.

5. The order assistance system of claim 1, wherein the customer device is configured to read a Uniform Resource Locator (URL) from a Near-Field Communication (NFC) tag, and wherein the first Internet-enabled application of the customer device uses the URL to transmit the initial order request.

6. The order assistance system of claim 1, wherein the first user interface enables selection of the request for order assistance by presenting a button associated with a Uniform Resource Locator (URL), and wherein the first Internet-enabled application of the customer device uses the URL to transmit the request for order assistance in response to selection of the button.

7. The order assistance system of claim 1, wherein the first and second user interfaces each use the transaction identifier to generate a first Uniform Resource Locator (URL) associated with the data connection and a second URL associated with the audio connection, and wherein:
the first Internet-enabled application of the customer device uses the first URL to transmit a first connection request;
the first Internet-enabled application of the customer device uses the second URL to transmit a second connection request;
the second Internet-enabled application of the order assistant device uses the first URL to transmit a third connection request; and
the second Internet-enabled application of the order assistant device uses the second URL to transmit a fourth connection request.

8. The order assistance system of claim 1, wherein the audio connection comprises one of a Web Real-Time Communication (WebRTC) connection, a Bluetooth connection, an Ultra-Wideband (UWB) connection, or a Voice over Internet Protocol (VoW) connection.

9. The order assistance system of claim 1, wherein the data connection comprises one of a Web Socket connection or a Web Real-Time Communication (WebRTC) connection.

10. The order assistance system of claim 1, wherein both of the first and second user interfaces enable the order to be viewed during the order session.

11. The order assistance system of claim 1, wherein at least one of the first and second user interfaces enables submission of order data during the order session, and wherein managing the order session includes updating the order to reflect the order data.

12. The order assistance system of claim 1, wherein at least one of the first and second user interfaces enables submission of payment data during the order session, and wherein managing the order session includes:
submitting the payment data to a payment system;
receiving a payment_status message from the order system; and
updating the order to reflect the payment_status.

13. The order assistance system of claim 1, wherein closing the order session comprises changing an order status of the order to reflect that the order is complete.

14. An order assistance system, comprising:
a processor;
a memory in data communication with the processor, the memory storing at least one computer program comprising instructions that, when executed by the processor, cause the processor to perform a plurality of operations comprising:
receiving a request for order assistance from a customer device of a customer and, in response, identifying an order assistant device of an order assistant available to assist with the request for order assistance;
transmitting a transaction identifier to each of the customer device and the order assistant device for use in transmitting a plurality of connection requests;
receiving the connection requests from the customer device and the order assistant device and, in response, establishing an audio connection and a data connection between the customer device and the order assistant device;
managing an order session by (a) enabling audio communication between the customer and the order assistant via the audio connection and (b) enabling the customer and the order assistant to create an order via the data connection and; and
closing the order session when the order is complete to enable fulfillment of the order.

15. The order assistance system of claim 14, wherein the customer device comprises one of a mobile phone, an in-vehicle computer, a personal computing tablet, a smart watch, a personal computer, or a laptop computer.

16. The order assistance system of claim 14, wherein the order assistant device comprises one of a mobile phone, a personal computing tablet, a smart watch, a personal computer, a laptop computer, or a point-of-sale terminal.

17. The order assistance system of claim 14, wherein the audio connection comprises one of a Web Real-Time Communication (WebRTC) connection, a Bluetooth connection, an Ultra-Wideband (UWB) connection, or a Voice over Internet Protocol (VoW) connection.

18. The order assistance system of claim 14, wherein the data connection comprises one of a WebSocket connection or a Web Real-Time Communication (WebRTC) connection.

19. The order assistance system of claim 14, wherein both of the customer device and the order assistant device enable viewing the order during the order session.

20. The order assistance system of claim 14, wherein at least one of the customer device and the order assistant device enables submission of order data during the order session, and wherein managing the order session includes updating the order to reflect the order data.

21. The order assistance system of claim 14, wherein at least one of the customer device and the order assistant device enables submission of payment data during the order session, and wherein managing the order session includes:
submitting the payment data to a payment system;
receiving a payment_status message from the order system; and
updating the order to reflect the payment_status.

22. The order assistance system of claim 14, wherein closing the order session comprises changing an order status of the order to reflect that the order is complete.

23. An order assistance system, comprising:
a processor;
a memory in data communication with the processor, the memory storing at least one computer program comprising instructions that, when executed by the processor, cause the processor to perform a plurality of operations comprising:
receiving a request for order assistance from a customer device of a customer;
establishing an audio connection and a data connection between the customer device and an order assistant device of an order assistant available to assist with the request for order assistance; and
managing an order session by (a) enabling audio communication between the customer and the order assistant via the audio connection and (b) enabling the customer and the order assistant to create an order via the data connection.

24. The order assistance system of claim 23, wherein the customer device comprises one of a mobile phone, an in-vehicle computer, a personal computing tablet, a smart watch, a personal computer, or a laptop computer.

25. The order assistance system of claim 23, wherein the order assistant device comprises one of a mobile phone, a personal computing tablet, a smart watch, a personal computer, a laptop computer, or a point-of-sale terminal.

26. The order assistance system of claim 23, wherein the audio connection comprises one of a Web Real-Time Communication (WebRTC) connection, a Bluetooth connection, an Ultra-Wideband (UWB) connection, or a Voice over Internet Protocol (VoW) connection.

27. The order assistance system of claim 23, wherein the data connection comprises one of a WebSocket connection or a Web Real-Time Communication (WebRTC) connection.

28. The order assistance system of claim 23, wherein both of the customer device and the order assistant device enable viewing the order during the order session.

29. The order assistance system of claim 23, wherein at least one of the customer device and the order assistant device enables submission of order data during the order session, and wherein managing the order session includes updating the order to reflect the order data.

30. The order assistance system of claim 23, wherein at least one of the customer device and the order assistant device enables submission of payment data during the order session, and wherein managing the order session includes:
submitting the payment data to a payment system;
receiving a payment status message from the order system; and
updating the order to reflect the payment status.
